(19) United States
(12) Patent Application Publication
(10) Pub. No.: US 2014/0099984 A2
(43) Pub. Date: Apr. 10, 2014

(54) User Scheduling Method and Base Station in Coordinated Scheduling

(71) Applicants: Kaibo TIAN, Shenzhen City, Guangdong Province (CN); Feng LI, Shenzhen City,Guangdong Province (CN); Changqing ZHU, Shenzhen City, Guangdong Province (CN); Aihua PENG, Shenzhen City, Guangdong Province (CN)

(72) Inventors: Kaibo TIAN, Shenzhen (CN); Feng LI, Shenzhen (CN); Changqing ZHU, Shenzhen (CN); Aihua PENG, Shenzhen (CN)

(73) Assignee: ZTE CORPORATION, ShenzhenCity, Guangdong Province (CN)

(21) Appl. No.: 13/380,864

(22) PCT Filed: Dec. 9, 2010
(86) PCT No.: PCT/CN2010/079624

§ 371 Date: Dec. 26, 2011

(30) Foreign Application Priority Data
Dec. 11, 2009 (CN) 200910254329.X

(51) Int. Cl. H04W 72/04; H04W 88/00

(52) U.S. Cl. 455/509

(57) ABSTRACT

The present invention discloses a method for scheduling users in coordinated scheduling, which is applied in a long term evaluation-advanced system, a coordinated cell determines and stores user pairing information in initial scheduling, and the coordinated cell uses the user pairing information that has been stored to determine a scheduled user in subsequent iterative scheduling. The present invention also discloses a corresponding base station. With the scheduling schemes in the present invention, in intra-cell scheduling, user pairing information is stored in an initial scheduling process and is used in subsequent iterative scheduling without performing multiple user pairing search in the iterative scheduling, which reduces the computation amount in the iterative scheduling and system resources occupied by the iterative scheduling and accelerates the system processing time in a premise of not reducing the system performance, thereby making the performance in the whole domain trend to the optimal.

### TECHNICAL FIELD

The invention relates to the user scheduling technique in the Long Term Evaluation-Advanced (LTE-A) system, and especially, to a method and a base station for scheduling a user in coordinated scheduling.

### BACKGROUND OF THE RELATED ART

In order to improve the coverage rate of the high speed data rate service and cell average throughput, Coordinated Multiple Point (COMP) transmission and reception technique is introduced into the LTE-A system.

In the current LTE-A system, the COMP technique is mainly divided into two parts:

(1) joint transmission technique: each node in the coordinated transmission set can obtain data information, and at the same time, data are transmitted by multiple nodes or one node through the Physical Downlink Shared Channel (PDSCH);

(2) coordinated scheduling: only the serving cell can obtain data information to be transmitted, but user scheduling and beamforming confirmation are completed through negotiation in the coordinated set.

In related art, coordinated cell scheduling users includes the intra-cell initial scheduling and inter-cell iterative scheduling once or multiple times, and the user scheduling is completed after multiple user pairing search in the iterative scheduling at each time. How to quickly and effectively select a scheduled user in coordinated scheduling is a problem to be solved in the related art.

### SUMMARY OF THE INVENTION

The technical problem to be solved by the present invention is to provide a method and a base station for scheduling a user in coordinated scheduling to reduce the computation amount in the iterative process and improve the system performance.

In order to solve the above problem, the present invention provides a method for scheduling a user in coordinated scheduling, which is applied in a long term evaluation-advanced system, and the method comprises: a coordinated cell determining and storing user pairing information in initial scheduling; and when each subsequent iterative scheduling starts, the coordinated cell obtaining scheduled user information determined in scheduling at a last time by other coordinated cells except the coordinated cell, and determining a pre-scheduled user in the coordinated cell according to an interference condition of users in the coordinated cell to a scheduled user determined by the other coordinated cells in combination with the user pairing information of the coordinated cell that has been stored in the initial scheduling.

The above method can further be characterized in that:

the pre-scheduled users in the coordinated cell are one or multiple users in the users of the coordinated cell without interference to the scheduled user determined by the other coordinated cells except the coordinated cell, or, first M users in the users of the coordinated cell that are sequenced according to a sequence from small to large interference degrees of the users of the coordinated cell to the scheduled user determined by the other coordinated cells; a number of users of the coordinated cell is N, and M is an integer that is greater than or equal to 1 and less than or equal to N.

The above method can further be characterized in that:

after determining the pre-scheduled user, when determining one or multiple user pairs in the user pairing information that is stored are included in the pre-scheduled users, the coordinated cell computes system performance corresponding to scheduling the user pairs, and respectively computes system performance corresponding to scheduling each user in the pre-scheduled users, and takes a user or user pair with best system performance as the a scheduled user that is determined.

The above method can further be characterized in that:

when the interference degrees of users in the coordinated cell to the scheduled user determined by the other coordinated cells are all greater than an interference threshold value set by a system, the coordinated cell does not set the pre-scheduled user in iterative scheduling at this time, and further does not set a scheduled user in the iterative scheduling at this time.

The above method can further be characterized in that:

the coordinated cell implements multiple times of iterative scheduling, and a condition for the coordinated cell stopping iterative scheduling is that:

the times of implementing iterative scheduling reaches times set by a system, or, the scheduled users who are determined in two consecutive times of iterative scheduling are same.

In order to solve the above problem, the present invention provides a base station in coordinated scheduling, which is applied in a long term evaluation-advanced system, and the base station comprises: an initial scheduling processing module and an iterative scheduling processing module; wherein the initial scheduling processing module is configured to: determine user pairing information in a process of processing initial scheduling of a coordinated cell, and store the user pairing information; the iterative scheduling processing module is configured to: use the user pairing information that has been stored to determine a scheduled user in iterative scheduling of the coordinated cell.

The above base station can further be characterized in that:

the iterative scheduling processing module is further configured to: obtain scheduled user information determined in scheduling at a last time by other coordinated cells except the coordinated cell when each iterative scheduling starts, and determine a pre-scheduled user in the coordinated cell according to an interference condition of users in the coordinated cell user to a scheduled user determined by the other coordinated cells.

The above base station can further be characterized in that:

the pre-scheduled users in the coordinated cell are one or multiple users in the users of the coordinated cell without interference to the scheduled user determined by the other coordinated cells, or, the first M users in the users of the coordinated cell that are sequenced according to a sequence from small to large interference degrees of the users of the coordinated cell to the scheduled user determined by the other coordinated cells; a number of users of the coordinated cell is N, and M is an integer that is greater than or equal to 1 and less than or equal to N.

The above base station can further be characterized in that:

the iterative scheduling processing module is further configured to: compute system performance corresponding to scheduling a user pair after determining the pre-scheduled user and when judging one or multiple user pairs in the user pairing information that is stored are included in the pre-scheduled users, and respectively compute system performance corresponding to scheduling each user in the pre-scheduled users, and take a user or user pair with best system performance as the scheduled user that is determined.

The above base station can further be characterized in that:

the iterative scheduling processing module is further configured to: not set the pre-scheduled user in the iterative scheduling at this time and further not set the scheduled user the iterative scheduling at this time when the interference degrees of users in the coordinated cell to the scheduled user determined by the other coordinated cells are all greater than an interference threshold value set by a system.

The above base station can further be characterized in that:

the iterative scheduling processing module is further configured to implement multiple times of iterative scheduling, wherein a condition for stopping iterative scheduling is that: the times of implementing iterative scheduling reaches times set by a system, or, the scheduled users who are determined in two consecutive times of iterative scheduling are same.

With the scheduling schemes in the present invention, in intra-cell scheduling, user pairing information is stored in an initial scheduling process and is used in subsequent iterative scheduling without performing multiple user pairing search in the iterative scheduling, which reduces the computation amount in the iterative scheduling and system resources occupied by the iterative scheduling and accelerates the system processing time in a premise of not reducing the system performance, thereby making the performance in the whole domain trend to the optimal.

### BRIEF DESCRIPTION OF DRAWINGS

FIG. 1 is a flowchart of the method for scheduling a user in coordinated scheduling according to the example

### PREFERRED EMBODIMENTS OF THE PRESENT INVENTION

The present invention is applied in the Long Term Evaluation-Advanced (LTE-A) system, and applicable coordinated domain of the present invention generally includes a plurality of coordinated cells, each coordinated cell can support the antenna mode of the Single-User Multi-Input Multi-Output (SU-MIMO) and Multi-User Multi-Input Multi-Output (MU-MIMO), the user in each coordinated cell independently measures the channel quality from itself to the serving cell where the user is located, and feeds the measurement information back to the serving cell.

The base station in coordinated scheduling includes an initial scheduling processing module and an iterative scheduling processing module.

The initial scheduling processing module is used to determine and store user pairing information in the process of processing the initial scheduling of the coordinated cell.

The iterative scheduling processing module is used to use the user pairing information that has been stored to determine the scheduled user in the iterative scheduling of the coordinated cell.

When each of iterative scheduling starts, the iterative scheduling processing module obtains the scheduled user determined in the scheduling at the last time by other coordinated cells, determines a pre-scheduled user in the present coordinated cell according to the situation of interference of users in the present coordinated cell to the scheduled user determined by the other coordinated cells. The determined pre-scheduled users are one or multiple users in the users of the present coordinated cell without interference to the scheduled users determined by the other coordinated cells, or, the first M users in users of the present coordinated cell that are sequenced according to a sequence from small to large interference degrees of the users of the present coordinated cell to the scheduled user determined by the other coordinated cells; the number of users of the present coordinated cell is N, and M is an integer that is greater than or equal to 1 and less than or equal to N.

When determining that one or multiple user pairs in the stored user pairing information are included in the pre-scheduled users after determining the pre-scheduled users, the iterative scheduling processing module computes the system performances corresponding to scheduling the user pairs, also respectively computes the system performances corresponding to scheduling each user in the pre-scheduled users, and takes a user or user pair with the best system performance as the determined scheduled user.

The iterative scheduling processing module can implement multiple times of iterative scheduling, and the conditions for stopping the iterative scheduling are: the times of implementing the iterative scheduling reach the times set by the system, or, the determined scheduled users are the same in two consecutive times of iterative scheduling.

When the interference degrees of the users in the present coordinated cell to the scheduled user determined by the other coordinated cells are all greater than the interference threshold value set by the system, the iterative scheduling processing module does not set a pre-scheduled user in the iterative scheduling at this time, and either does not set a scheduled user in the iterative scheduling at this time.

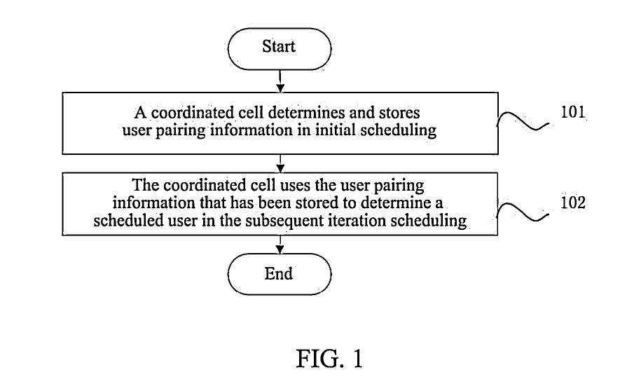

As shown in FIG. 1, a method for scheduling a user in coordinated scheduling comprises following steps.

Step 101, a coordinated cell determines and stores user pairing information in initial scheduling;

an initial scheduling refers to each coordinated cell schedules the present cell at the first time without regard to the information of other cells. Specifically, the coordinated cell completes the initial scheduling of this cell without regard to the scheduling conditions of the other cells after receiving channel measurement information from user in this cell, multiple users can be scheduled in the condition that the channel state permits, all possible user pairing information is stored. User pairing refers that two orthogonal or quasi-orthogonal users (namely the user pair) determined according to channel information of users or two users who meet certain performance requirements can be used in pairs.

The pairing information mentioned in the present invention is pairing information which meets the performance requirements set by the system. The performance requirements set by the system can be the interference intensity (or called as the orthogonal degree) between two users.

Step 102, the coordinated cell uses the user pairing information that has been stored to determine a scheduled user in subsequent iterative scheduling.

The coordinated cell can implement multiple times of iterative scheduling, and each of iterative scheduling includes the following steps.

(a) The coordinated cell obtains the scheduled user determined by the other coordinated cells in the scheduling at the last time.

The scheduling at the last time is the initial scheduling during the scheduling at the first time.

(b) The coordinated cell determines a pre-scheduled user of the present coordinated cell according to interference condition of users in the present coordinated cell to the scheduled user determined by the other coordinated cells.

The pre-scheduled users of the present coordinated cell are one or multiple users in the present coordinated cell without interference to the scheduled users determined by the other coordinated cells, or, the first M users in users of the present coordinated cell that are sequenced according to a sequence from small to large interference degrees of the users of the present coordinated cell to the scheduled user determined by the other coordinated cells; the number of users of the present coordinated cell is N, and M is an integer that is greater than or equal to 1 and less than or equal to N.

The system can also set an interference threshold value for determining the interference degree of users in the present coordinated cell to the users of other coordinated cells. When the interference degrees of users of the present coordinated cell to the scheduled user determined by the other coordinated cells are all greater than the interference threshold value set by the system, it denotes that the interference beyond the system acceptability to other cells will be formed no matter which user is scheduled in the present cell, and therefore, a pre-scheduled user is not set by the coordinated cell in the iterative scheduling at this time and further a scheduled user is either not set in the iterative scheduling at this time.

(c) when it is determined that one or multiple user pairs in the stored user pairing information are included in the pre-scheduled users after determining the pre-scheduled users, the coordinated cell computes the system performance corresponding to schedule the user pairs, also respectively computes the system performance corresponding to schedule each user in the pre-scheduled users, and takes a user or user pair with the best system performance as the determined scheduled user.

The coordinated cell can implement multiple times of iterative scheduling, and the conditions for stopping the iterative scheduling of the coordinated cell are: the times of implementing iterative scheduling reach the times set by the system, or, the determined scheduled users are the same in two consecutive times of iterative scheduling.

In the above method, in intra-cell scheduling, user pairing information is stored in an initial scheduling process, and is used in subsequent iterative scheduling without performing multiple user pairing search in iterative scheduling, which reduces the computation amount in the iterative scheduling and system resources occupied by the iterative scheduling and accelerates the system processing time in a premise of not reducing the system performance, thereby making the performance in the whole domain trend to the optimal.

The present invention can be implemented through a centralized way, a distributed way or a combination of the two ways. The centralized way refers that the information of users to be scheduled of all the coordinated cells are gathered into a central control point, and the central control point independently completes the iterative scheduling and finally transmits the scheduling results to the corresponding coordinated cells; the distributed way refers that each coordinated cell obtains the pre-scheduling information of other coordinated cells alone, completes the pre-scheduling of the present cell independently, and sends the pre-scheduling information of the present cell to the other coordinated cells; a combination of the two ways can be called as a relay way.

A specific example of the present invention applied in a relay coordinated network is provided in the following. In this specific example, a condition of ending the iterative scheduling is that the determined scheduled users are the same in two consecutive times of iterative scheduling (i.e. reaching a convergence).

It is assumed that there are 3 coordinated cells in the domain, and they are coordinated cell A, coordinated cell B and coordinated cell C respectively. Each coordinated cell can support modes of MU-MIMO and SU-MIMO, and there are 3 users to be scheduled in the coordinated resources of each coordinated cell.

Users to be scheduled in the coordinated cell A are respectively called: user a1, user a2, user a3.

Users to be scheduled in the coordinated cell B are respectively called: user b1, user b2, user b3.

Users to be scheduled in the coordinated cell C are respectively called: user c1, user c2, user c3.

It is assumed that strong interference will be formed between user a2 and user c2 and on the first stream of user a2 and user b3 and on the second stream of user c3 and user b3. It is also assumed that coordinated cell C with the smallest traffic is selected as a relay cell.

Initial Pre-Scheduling

3 coordinated cells independently implement the scheduling of the present cell without regard to other coordinated cells.

Coordinated cell A completes initial pre-scheduling of the present cell with a comprehensive consideration of fairness and current channel states of each user to be scheduled, and determines that a2 is the initial scheduled user and users a1 and a3 can be paired.

Coordinated cell B completes initial pre-scheduling of the present cell with a comprehensive consideration of fairness and current channel states of each user to be scheduled, and determines that b3 is the initial scheduled user and user b3 can simultaneously transmit 2 streams and users to be scheduled in the present cell do not have a matched user to be paired; the scheduling is called as the mode of SU-MIMO.

Coordinated cell C completes initial pre-scheduling of the present cell with a comprehensive consideration of fairness and current channel states of each user to be scheduled, and determines that c2 and c3 are the initial scheduled users; the scheduling is the mode of MU-MIMO.

When the initial pre-scheduling of 3 coordinated cells is completed, the scheduling results and information related to scheduled users are respectively transmitted to a relay cell; the relay cell gathers the scheduling information of other cells and transmits all the scheduling information to all the coordinated cells; each coordinated cell receives all the latest scheduling information transmitted from the relay cell and recomputes the scheduling schemes of the present cell.

The First Iterative Pre-Scheduling

In addition to the consideration of fairness and current channel states of each user to be scheduled, coordinated cell A should also consider the scheduling of coordinated cell B (scheduling user b3 and using 2 streams) and the scheduling of coordinated cell C (simultaneously scheduling user c2 and user c3), that is, when meeting certain performance of the present cell, the performance loss induced to the other coordinated cells should also be taken into consideration, and the initial scheduling of the present cell is further completed.

In the scheduling process, the scheduled possibility of the 3 users in the present cell is recomputed in a case of assuming that b3, c2, and c3 have been scheduled. The first stream of user a2 and user b3 has strong interference, and user a2 has interference with user c2, so the scheduling priority of a2 is the lowest. Users without interference to the scheduled user determined by the other coordinated cells are a3 and a1, and the pre-scheduled users in the first iterative scheduling are a3 and a1. The coordinated cell A determines that a3 and a1 in the stored pairing information of the initial scheduling can be paired, computes the corresponding system performance when simultaneously scheduling a3 and a1, and computes the corresponding system performance when independently scheduling a3 or a1. When the performance of simultaneously scheduling a3 and a1 is better than that of independently scheduling a3 or a1, a3 and a1 are determined as the scheduled users.

In other specific examples, in addition to determining the users in the present coordinated cell without interference to the scheduled user determined by the other coordinated cells as the pre-scheduled users as mentioned above, the pre-scheduled users also can be the first M users in users of the present coordinated cell that are sequenced according to a sequence from small to large interference degrees of the users of the present coordinated cell to the scheduled user determined by the other coordinated cells; the number of users of the present coordinated cell is N, and M is an integer that is greater than or equal to 1 and less than or equal to N. For example, the sequence is a3, a1, a2, and the first two users are determined as the pre-scheduled users.

After determining multiple pre-scheduled users, the sequence of scheduling priorities thereof can also be determined according to the current channel states of each user.

In addition to the consideration of fairness and the current channel states of each user to be scheduled, coordinated cell B should also consider the scheduling of coordinated cell A (user a2) and the scheduling of coordinated cell C (simultaneously scheduling user c2 and user c3), that is, when meeting certain performance of the present cell, the performance loss induced to the other coordinated cells should also be taken into consideration, and the initial scheduling of the present cell is further completed.

In the scheduling process, the scheduled possibility of the 3 users in the present cell is recomputed in a case of assuming that a2, c2, and c3 have been scheduled. The first stream of user a2 and user b3 has strong interference, and the second stream of user c3 and user b3 has strong interference, so the scheduling priority of b3 is the lowest. Users without interference to the scheduled users determined by the other coordinated cells are b1 and b2, and the pre-scheduled users in the first iterative scheduling are b1 and b2. The pairing information stored in the initial scheduling is searched, there is no other pairing information except that b3 can use 2 streams, and therefore b2 is determined as the scheduled user.

In addition to the consideration of fairness and the current channel states of each user to be scheduled, coordinated cell C should also consider the scheduling of coordinated cell A (user a2) and the scheduling of coordinated cell B (scheduling user b3 and using 2 streams), that is, when meeting certain performance of the present cell, the performance loss induced to the other coordinated cells should also be taken into consideration, and the initial scheduling of the present cell is further completed.

In the scheduling process, the scheduled possibility of the 3 users in the present cell is recomputed in a case of assuming that a2 and b3 have been scheduled. The second stream of user c3 and user b3 has strong interference, and there is strong interference between user a2 and user c2, so the scheduling priorities of c3 and c2 are the lowest. The pairing information stored in the initial scheduling is searched, c3 and c2 can be paired, and the performance of simultaneously scheduling the two users is recomputed. Based on computation, the performance of simultaneously scheduling the two users is still worse than the performance of independently scheduling c1, so the pre-scheduling result at this time is c1.

When the first iterative pre-scheduling of 3 coordinated cells is completed, the scheduling results and information related to scheduled users are respectively transmitted to a relay cell; the relay cell first judges whether the scheduling result at this time is completely consistent with the scheduling result at the last time after gathering the scheduling information of other cells, if the scheduling result at this time is not completely consistent with the scheduling result at the last time, that is, a convergence state is not reached, then the relay cell transmits all the scheduling information at this time to all the coordinated cells again; each coordinated cell receives all the latest scheduling information transmitted from the relay cell and recomputes the scheduling schemes of the present cell.

The Second Iterative Pre-Scheduling

In addition to the consideration of fairness and current channel states of each user to be scheduled, coordinated cell A also considers the pre-scheduled user b2 of coordinated cell B and pre-scheduled user c1 of coordinated cell C, and further completes initial scheduling of the present cell. In the scheduling process, the scheduled possibility of the 3 users in the present cell is recomputed in a case of assuming that b2 and c1 have been scheduled, and the possibility from the large to the small of single user who is scheduled is in an order of: a3, a1, a2; the pairing information stored in the initial scheduling is searched, a3 and a1 can be paired, the performance of simultaneously scheduling the paired users is computed, and the performance of simultaneously scheduling the paired users is better than the performance of independently scheduling a3, so the pre-scheduling result at this time is user a1 and user a3, which is consistent with the scheduling result at the last time.

In addition to the consideration of fairness and current channel states of each user to be scheduled, coordinated cell B should also consider the pre-scheduled users a1 and a3 of coordinated cell A and the pre-scheduled user c1 of coordinated cell C, and further completes the initial scheduling of the present cell. In the scheduling process, the scheduled possibility of the 3 users in the present cell is recomputed in a case of assuming that a1, a3 and c1 have been scheduled, and the possibility from the large to the small of single user who is scheduled is in an order of: b2, b3, b1; the pairing information stored in the initial scheduling is searched, and b3 can use 2 streams. Based on computation, the performance of simultaneously scheduling the 2 streams of b3 is worse than the performance of independently scheduling b2, so the pre-scheduling result at this time is b2, which is consistent with the scheduling result at the last time.

In addition to the consideration of fairness and current channel states of each user to be scheduled, coordinated cell C should also consider the pre-scheduled user a1 and user a3 of coordinated cell A and pre-scheduled user b2 of coordinated cell B, and further completes initial scheduling of the present cell. In the scheduling process, the scheduled possibility of the 3 users in the present cell is recomputed in a case of assuming that a1, a3 and b2 have been scheduled, and the possibility from the large to the small of single user who is scheduled is in an order of: c1, c3, c2; the pairing information stored in the initial scheduling is searched, c3 and c2 can be paired, and the performance of simultaneously scheduling the two users is recomputed. Based on computation, the performance of simultaneously scheduling the two users is better than the performance of independently scheduling c1, so the pre-scheduling result at this time is user c2 and user c3.

When the second iterative pre-scheduling of 3 coordinated cells is completed, the scheduling results and information related to scheduled users are respectively transmitted to a relay cell; the relay cell first judges whether the scheduling result at this time is completely consistent with the scheduling result at the last time after gathering the scheduling information of other cells, if the scheduling result at this time is not completely consistent with the scheduling result at the last time, that is, a convergence state is not reached, then the relay cell transmits all the scheduling information at this time to all the coordinated cells again; each coordinated cell receives all the latest scheduling information transmitted from the relay cell and recomputes the scheduling schemes of the present cell.

The Third Iterative Per-Scheduling

In addition to the consideration of fairness and current channel states of each user to be scheduled, coordinated cell A also considers the pre-scheduled user b2 of coordinated cell B and pre-scheduled user c2 and c3 of coordinated cell C, and further completes initial scheduling of the present cell. In the scheduling process, the scheduled possibility of the 3 users in the present cell is recomputed in a case of assuming that b2, c2 and c3 have been scheduled, and the possibility from the large to the small of single user who is scheduled is in an order of: a3, a1, a2; the pairing information stored in the initial scheduling is searched, a3 and a1 can be paired, the performance of simultaneously scheduling the paired users is computed, and the performance of simultaneously scheduling the paired users is better than the performance of independently scheduling a3, so the pre-scheduling result at this time is user a1 and user a3, which is consistent with the scheduling result at the last time.

In addition to the consideration of fairness and current channel states of each user to be scheduled, coordinated cell B should also consider the pre-scheduled users a1 and a3 of coordinated cell A and the pre-scheduled users c2 and c3 of coordinated cell C, and further completes the initial scheduling of the present cell. In the scheduling process, the scheduled possibility of the 3 users in the present cell is recomputed in a case of assuming that a1, a3, c1 and c3 have been scheduled, and the possibility from the large to the small of single user who is scheduled is in an order of: b2, b1, b3; the pairing information stored in the initial scheduling is searched, and b3 can use 2 streams. Based on computation, the performance of simultaneously scheduling the 2 streams of b3 is worse than the performance of independently scheduling b2, so the pre-scheduling result at this time is b2, which is consistent with the scheduling result at the last time.

In addition to the consideration of fairness and the current channel states of each user to be scheduled, coordinated cell C should also consider the pre-scheduled user a1 and user a3 of coordinated cell A and pre-scheduled user b2 of coordinated cell B, and further completes initial scheduling of the present cell. In the scheduling process, as the pre-scheduling results at the last time of coordinated cell A and coordinated cell B are unchanged, so the pre-scheduling result at this time is still the pre-scheduling result at the last time, that is, scheduled users c2 and c3.

When the third iterative pre-scheduling of 3 coordinated cells is completed, the scheduling results and information related to scheduled users are respectively transmitted to a relay cell; the relay cell first judges whether the scheduling result at this time is completely consistent with the scheduling result at the last time after gathering the scheduling information of other cells, if the scheduling result at this time is completely consistent with the scheduling result at the last time, that is, a convergence state is reached, then the relay cell notifies all the coordinated cells of the scheduling reaching the optimal state, and the scheduling ends; each coordinated cell receives the scheduling completion information transmitted from the relay cell and implements a corresponding scheduling according to the final iterative result.

When coordinated cells and users to be scheduled increase, final convergence acting as a condition of completing the iteration may need very large times of iterations, or may be unable to obtain a final convergence state, and therefore a condition of determining that the iteration ends can also be the limitation of the times of iterations or the whole domain meeting a certain performance threshold.

The above description is just the preferred examples of the present invention, which is not used to limit the present invention. The present invention can have various modifications and changes for those skilled in the art. Any modifications, equivalent substitutions, and improvements, etc. made within the spirit and principle of the present invention shall all fall into the protection scope of the present invention.

### INDUSTRIAL APPLICABILITY

With the scheduling schemes in the present invention, in intra-cell scheduling, user pairing information is stored in an initial scheduling process and is used in subsequent iterative scheduling without performing multiple user pairing search in the iterative scheduling, which reduces the computation amount in the iterative scheduling and system resources occupied by the iterative scheduling and accelerates the system processing time in a premise of not reducing the system performance, thereby making the performance in the whole domain trend to the optimal.

What is claimed is:

1. A method for scheduling users in coordinated scheduling, which is applied in a long term evaluation-advanced system, and the method comprising:
a coordinated cell determining and storing user pairing information in initial scheduling; and
when each subsequent iterative scheduling starts, the coordinated cell obtaining scheduled user information determined in scheduling at a last time by other coordinated cells except the coordinated cell, and determining a pre-scheduled user in the coordinated cell according to an interference condition of users in the coordinated cell to a scheduled user determined by the other coordinated cells in combination with the user pairing information of the coordinated cell that has been stored in the initial scheduling.

2. The method according to claim 1, wherein
the pre-scheduled users in the coordinated cell are one or multiple users in the users of the coordinated cell without interference to the scheduled user determined by the other coordinated cells except the coordinated cell, or, first M users in the users of the coordinated cell that are sequenced according to a sequence from small to large interference degrees of the users of the coordinated cell to the scheduled user determined by the other coordinated cells; a number of users of the coordinated cell is N, and M is an integer that is greater than or equal to 1 and less than or equal to N.

3. The method according to claim 2 further comprising:
after determining the pre-scheduled user, when determining one or multiple user pairs in the user pairing information that is stored are included in the pre-scheduled users, the coordinated cell computing system performance corresponding to scheduling the user pairs, and respectively computing system performance corresponding to scheduling each user in the pre-scheduled users, and taking a user or user pair with best system performance as the a scheduled user that is determined.

4. The method according to claim 2 further comprising:
when the interference degrees of users in the coordinated cell to the scheduled user determined by the other coordinated cells are all greater than an interference threshold value set by a system, the coordinated cell not setting the pre-scheduled user in iterative scheduling at this time, and further not setting a scheduled user in the iterative scheduling at this time.

5. The method according to claim 3, wherein
the coordinated cell implements multiple times of iterative scheduling, and a condition for the coordinated cell stopping iterative scheduling is that:
the times of implementing iterative scheduling reaches times set by a system, or, the scheduled users who are determined in two consecutive times of iterative scheduling are same.

6. A base station in coordinated scheduling, which is applied in a long term evaluation-advanced system, and the base station comprising: an initial scheduling processing module and an iterative scheduling processing module; wherein
the initial scheduling processing module is configured to: determine user pairing information in a process of processing initial scheduling of a coordinated cell, and store the user pairing information;
the iterative scheduling processing module is configured to: use the user pairing information that has been stored to determine a scheduled user in iterative scheduling of the coordinated cell.

7. The base station according to claim 6, wherein
the iterative scheduling processing module is further configured to: obtain scheduled user information determined in scheduling at a last time by other coordinated cells except the coordinated cell when each iterative scheduling starts, and determine a pre-scheduled user in the coordinated cell according to an interference condition of users in the coordinated cell user to a scheduled user determined by the other coordinated cells.

8. The base station according to claim 7, wherein
the pre-scheduled users in the coordinated cell are one or multiple users in the users of the coordinated cell without interference to the scheduled user determined by the other coordinated cells, or, the first M users in the users of the coordinated cell that are sequenced according to a sequence from small to large interference degrees of the users of the coordinated cell to the scheduled user determined by the other coordinated cells; a number of users of the coordinated cell is N, and M is an integer that is greater than or equal to 1 and less than or equal to N.

9. The base station according to claim 7, wherein
the iterative scheduling processing module is further configured to: compute system performance corresponding to scheduling a user pair after determining the pre-scheduled user and when judging one or multiple user pairs in the user pairing information that is stored are included in the pre-scheduled users, and respectively compute system performance corresponding to scheduling each user in the pre-scheduled users, and take a user or user pair with best system performance as the scheduled user that is determined.

10. The base station according to claim 8, wherein
the iterative scheduling processing module is further configured to: not set the pre-scheduled user in the iterative scheduling at this time and further not set the scheduled user the iterative scheduling at this time when the interference degrees of users in the coordinated cell to the scheduled user determined by the other coordinated cells are all greater than an interference threshold value set by a system.

11. The base station according to claim 9, wherein
the iterative scheduling processing module is further configured to implement multiple times of iterative scheduling, wherein a condition for stopping iterative scheduling is that: the times of implementing iterative scheduling reaches times set by a system, or, the scheduled users who are determined in two consecutive times of iterative scheduling are same.

12. The base station according to claim 8, wherein
the iterative scheduling processing module is further configured to: compute system performance corresponding to scheduling a user pair after determining the pre-scheduled user and when judging one or multiple user pairs in the user pairing information that is stored are included in the pre-scheduled users, and respectively compute system performance corresponding to scheduling each user in the pre-scheduled users, and take a user or user pair with best system performance as the scheduled user that is determined.

13. The base station according to claim 12, wherein
the iterative scheduling processing module is further configured to implement multiple times of iterative scheduling, wherein a condition for stopping iterative scheduling is that: the times of implementing iterative scheduling reaches times set by a system, or, the scheduled users who are determined in two consecutive times of iterative scheduling are same.
